(19) United States
(12) Patent Application Publication
(10) Pub. No.: US 2015/0129388 A1
(43) Pub. Date: May 14, 2015

(54) COMBINED FRICTION DISC/LIQUID FRICTION COUPLING

(71) Applicant: Kendrion (Markdorf) GmbH, Markdorf (DE)

(72) Inventors: Christian Tilly, Uhldingen-Muehlhofen (DE); Matthias Busch, Meersburg (DE)

(21) Appl. No.: 14/383,578

(22) PCT Filed: Feb. 15, 2013
(86) PCT No.: PCT/EP2013/053128

§ 371 Date: Sep. 8, 2014

(30) Foreign Application Priority Data
Mar. 12, 2012 (DE) 10 2012 102 058.2

(51) Int. Cl. F04D 13/02; F16D 13/58; F16D 21/00; F16D 35/02

(52) U.S. Cl. CPC F04D 13/021; F16D 35/02; F16D 35/024; F16D 35/022; F16D 13/58; F16D 21/00
USPC 192/48.3

(57) ABSTRACT

A coupling assembly for transferring a drive torque from a drive shaft (2) to a secondary unit, of a motor vehicle, including a drive shaft (2), an output (9) with at least one friction surface (20, 30), an armature (7) that is adjustable relative to the output (9) by energising an energisable winding (4) and that has friction coupling means with a friction surface (19, 25), as well as at least one liquid friction coupling means with a shear gap (21, 29, 52) filled with a fluid (16), wherein the friction coupling means and the liquid friction coupling means are part of a common coupling (14) designed as a combined friction disc and liquid friction coupling in which the adjustable armature (7) delimits the shear gap (21, 29, 52).

### BACKGROUND OF THE INVENTION

The invention relates to a coupling assembly for transferring a drive torque to a secondary unit, more particularly a fan wheel, of a motor vehicle.

Single or multiple-step friction disc couplings for actuating secondary units, such as fan wheels are fundamentally known. Such friction disc couplings, designed in the form of electromagnetically operable couplings, for example, are described EP 0 317 703 A2, DE 32 031 43 C2 or DE 42 07 10 C2. Reference is made to these publications with regard to the basic design, mode of action and areas of application of such friction disc couplings. In the state of the art, instead of couplings with an electromagnetic switch mechanism, pneumatically or hydraulically-operated friction disc couplings are used.

In order to produce a rotational speed-dependent drag torque without variable speed setting, it is known to provide electromagnetic coupling assemblies with an eddy current mechanism. Due to the required strong magnetic forces, costly permanent magnets have to be used, resulting in cost disadvantages of the known technology.

In place of the above-described friction disc couplings, in order to actuate secondary units of motor vehicles so-called liquid friction couplings, also known as viscous couplings or viscosity couplings, are used. In the case of viscous couplings a torque is transferred from a primary side to a fluid and from this then to a secondary side of the coupling.

With regard to the basic design of liquid friction couplings reference is made to U.S. Pat. No. 4,305,491 as well as EP 1 248 007 B1. In contrast to single-step friction disc couplings, liquid friction couplings have a relatively sluggish response behaviour and are also affected by high slip values.

From DE 102 32 138 A1, the use of two different couplings in one drive train to actuate a cooling agent pump in a motor vehicle is known. In the known arrangement, in addition to a liquid friction coupling, in order to actuate a cooling agent pump in the same drive train an electromagnetic switch coupling is provided which can be operated in parallel with the liquid friction coupling in order to bring about increased redundancy and rotational speed regulation in two stages.

From DE 31 48 014 A1 a coupling assembly for actuating a cooling fan of an internal combustion engine is known, wherein here too two separate couplings are provided in one drive train, namely a freewheeling viscous coupling and an electromagnetic coupling.

The aforementioned combination of the viscous coupling technology and friction disc coupling technology in a joint drive can provide considerable advantages. Disadvantageous, however, is the increased cost due to the necessity of providing two separate couplings. Furthermore, the design costs are considerable and a relatively large installation space is needed.

### SUMMARY OF THE INVENTION

On the basis of the above-mentioned state of the art, the aim of the invention is to minimise the installation space in the case of a combination of the viscous coupling technology and the friction disc coupling technology as well as the design configuration. Preferably a cost-intensive eddy current mechanism should be able to be dispensed with.

This objective is achieved with a coupling assembly with the features disclosed herein. Advantageous further embodiments of the invention are also set out herein. The scope of the invention covers all combinations of at least two of the features disclosed in the description, the claims and/or the figures.

The invention is based on the idea of completely integrating the comparatively cost-effective viscous torque transmission mechanism, controlled via a control valve or uncontrolled, into an electromagnetic friction disc coupling concept. In other words, the invention is based on the idea of making the friction disc coupling means and the liquid friction coupling means part of a common coupling designed as a combined friction disc and liquid friction coupling, wherein in accordance with the invention the armature, more particularly designed as an armature disc, which is adjustable by energising the energisable winding, delimits the shear gap. Expressed in yet another way, the armature of the electromagnetic coupling also acts as the primary disc of the viscous coupling. The armature therefore has a dual function. Via it, in the event of appropriate energising of the energisable winding, through friction contact with the drive the full torque can be transferred from the drive shaft to the drive. If there is no friction contact the armature, preferably together with the output, delimits at least one shear gap filled with fluid, in particular oil, i.e. it has the function of a rotor of a liquid friction coupling and via shearing of the fluid in the gap transfers a drag torque onto the output. Preferably, the armature, preferably designed as an armature disc, is fixed to the drive shaft in a torque-proof manner.

Particularly preferably, but not compulsorily, a cost-intensive eddy current mechanism is deliberately dispensed with in such a coupling assembly. Through fully integrating the two torque transfer technologies in a common coupling the required installation space is reduced to a minimum, as is the overall design cost. In addition, through the provision of a common housing for example, material and assembly costs can be minimised in comparison with the provision of two separate, different couplings. As indicated in the introduction, it is particularly expedient if the at least one shear gap is formed between the armature and the output when the armature is not in contact with the drive, i.e. when the friction disc coupling means are not interconnected, whereby it especially preferred if the shear gap is formed, at least in parts, preferably completely, between the at least one friction surface of the armament and the at least one, preferably axially opposite, friction surface of the output.

It is particularly expedient if the fluid, preferably in the form of oil, even more preferably silicone oil, for transferring the torque in the shear gap has a viscosity in a value range between 500 and 30,000 cst.

As the friction between the at least one friction surface of the armament and the at least one friction surface of the output is reduced in comparison with a pure friction disc coupling solution because of the fluid, more particular the viscous oil, in the shear gap, it is particularly preferred if the geometry of the armament and the output is selected so that comparatively large friction surfaces result in order to increase the maximum transferrable torque in the event of friction contact. For this it is particularly expedient if the friction surface of the armament and the corresponding friction surface of the output run at an angle to the radial plane of the armature, i.e. at an angle to a perpendicular of the drive shaft, wherein it is particularly expedient if the armament and the output, or their friction surfaces, are conical, at least in sections, in order to increase the contact surfaces (friction surfaces).

At the same time, through this measure the size of the shear surface(s) is increased resulting in an increased drag torque.

It is particularly expedient if the armature and output do not only have one friction surface each but are each provided with at last two friction surfaces, which even more preferably are at a distance from one another in the radial direction. It is especially expedient if two conically contoured friction surface pairs are provided between the armature and output, whereby preferably two friction surfaces of the output are at a distance from one another through a magnetic separator, made of bronze for example, in order to force the magnetic flux via the fluid-filled air gap between the output and the armature. It has proven to be particularly advantageous if the armature has at least two pole pieces, each even more preferably bearing a conically contoured friction surface.

It is particularly expedient if a gap, provided on the side facing away from the energisable winding, between the armature and a further coupling component, more particularly a coupling housing attached to the output in a torque-proof manner, is formed as a straight axial gap and/or has a smaller surface size than that of the at least one shear gap, preferably all shear gaps and/or a mean gap width that is greater than the mean gap width of all shear gaps.

In a further development of the invention, in addition to the shear gap delimited by the armature, a shear gap delimited by the armature adjustable by energising the energisable winding (constant shear gap) is provided, more particularly on a side facing away from the friction surface of the armature. The at least one shear gap not delimited by the armature is preferably characterised through a constant gap width, i.e. a gap width which cannot be changed by adjusting the armature. Preferably, in order to delimit the aforementioned constant shear gap, on the drive side, more particularly on the drive shaft, a comparatively rigid disc is attached, which preferably, together with the surface side facing away from the armature delimits the constant shear gap, which is delimited on the opposite output side, more particularly by a part of the housing. It is very particularly preferred if the constant shear gap and the shear gap delimited by the armature are connected in a fluid-conveying manner which can be particularly advantageously achieved in that the constant shear gap and the shear gap delimited by the armature are arranged in a common operating space. Preferably an aforementioned rigid disc to delimit the constant shear gap and the preferably axially adjustable armature are jointly provided in this operating space.

In accordance with a very specially preferred example of embodiment, the aforementioned rigid disc, i.e. not in the form of a spring washer, is simultaneously a carrier disc for the return spring of the armature. In an alternative form of embodiment the armature, i.e. the armature disc, is directly connected to the shaft via a return spring, whereby, in addition, the rigid disc, connected to the shaft in a torque-proof manner, is then provided and primarily only functions to delimit the constant shear gap.

It is particularly preferable if the constant shear gap(s) provided between the friction surfaces in addition to the shear gap is/are designed as main shear gap(s) in such a way that it/they transfer a main drag torque. In other words the at least one constant shear gap arranged facing away from the friction surfaces or variable shear gap not delimited by the opposing friction surfaces is dimensioned in such a way that with it a larger maximum drag torque can be transferred than with the variable shear gap delimited by the friction surfaces. This is preferably implemented in that the aforementioned constant shear gap has a larger surface size, i.e. a larger shear surface. In addition, the at least one constant shear gap is designed as a so-called gap labyrinth which is characterised by a multiply changing direction of the shear gap. Preferably the constant shear gap runs alternately in the axial and radial direction, i.e. the axial and radial shear gap pairs alternate. The component delimiting the constant shear gap on the drive side, more particularly a disc fixed on a drive shaft, and a component of the output, more particularly a housing component, engage with each other in the axial direction in an interlocking-like manner, wherein the interlocking contour is preferably, but not compulsorily, essentially rectangular.

By providing at least one constant shear gap on a side facing away from the friction surface of the armature the maximum drag torque can be considerably increased.

A form of embodiment is also conceivable in which the shear gap delimited by the armature is designed as a labyrinth gap. In this case the armature and pole disc piece axially interlock with each other.

This form of embodiment can be combined with an at least partially conical design of the armature and the pole surface piece. The form of embodiment with a labyrinth shear gap between the armature and pole surface piece can be implemented with or without a constant shear gap. The form of embodiment is characterised in that the shear gap, preferably designed as a labyrinth, particular in the conical version, simultaneously forms the friction surface of the armature and the output.

Such a form of embodiment is of particular interest if, as will be explained later, the viscous coupling means (liquid friction coupling means) is variable/adjustable in order to be able to adjust the filling level of the fluid, more particularly a viscous oil, in the shear gap delimited by the armature, preferably in all shear gaps, wherein the mechanism for controlling the fluid flow in the viscous coupling section can comprise a bi-metal arrangement or alternatively electromagnetic means for operating a fluid valve (control valve) in the fluid circulation of the viscous coupling.

In order to optimise the friction ratios between the armature and output in the interconnected state of the friction disc coupling means it is particularly preferably if the friction surface of the armature and/or the friction surface of the output is/are formed of a coating, more particularly an organic coating, that increases the adhesive friction.

Due to lack of fluid, conventional pure friction disc couplings are not fluid-tight. The combined coupling proposed here preferably has a fluid-tight operating space accommodating the armature, whereby even more preferably, to seal this operating space at least one elastomer seal, preferably an O-ring seal, is provided, which yet more preferably is arranged radially and/or axially between a component on the output side forming or bearing the electromagnetic side friction surface and a housing component on the output side that delimits the operating space.

Very particularly preferred is a form of embodiment in which means for setting different shear gap widths are provided. In other words the mean shear gap can be set and maintained in order to be able to set/vary the drag torque being transferred between the armature and output. The drag torque increases as the gap becomes smaller. Preferred are different gap widths which are adjustable in a range between around 1/10 mm and around 8/10 mm and can, after adjustment, be maintained, e.g. through appropriate energising of the winding.

One possibility of setting the shear gap width is through energising the energisable winding with a modulated current, more particularly a pulse width modulated current (PWM current). Particularly preferably a low-frequency PWM frequency is selected. The resulting shear gap width is thus dependent on the PWM signal. Particularly preferably the control means are designed in such a way that the PWM signal is variable in order to be able to set a large number of different shear gap widths.

Preferably the shear gap is only zero on maximum envisaged energising of the energisable winding and only then does the coupling synchronise via the friction contact between the output and armature.

In other words, the energisable winding can be energised via the control means preferably with different effective current strengths, whereby effective current strength is taken to mean the flow-relevant current strength, i.e. the current strength of energising the electromagnet assembly (winding energising), that is available for producing the magnetic field or to which the produced magnetic field or produced magnetic flux is functionally connected. If, for example, the electromagnet assembly is energised with constant direct currents (which is possible as an alternative to PWM energising), the effective current strength is taken to mean this constant current strength (not pulsed currents). If, as preferred, the electromagnet assembly is energised with a PWM signal, the effective current strength is taken to mean the resulting current flow or mean current flow in a certain time interval, more particularly a period. It is particularly expedient if the gap can be adjusted in several stages or continuously through the selection of different effective current strengths in order to allow particularly good modulation of the slip of the liquid friction coupling. The different effective current strengths can, for example, be set by energising with different PWM duty cycles or through different constant current levels (not pulsed currents). The PWM duty cycle is the ratio within a period between the proportion of time in which the current is switched on and the proportion of time in which the current is switched off.

Particularly preferably, through the use of a PWM frequency of less than 10 Hz a cyclic actuation of the shear gap dimension between the armament disc and output can be achieved which, due to the inertias of the overall system, is not reflected in significant torque and thereby rotational speed fluctuations. The mean gap dimension over time corresponds with the transferred torque. This type of modulation can also result proportionality in the case of switching magnets and reduce hysteresis effects.

In addition or alternatively to shear gap variation, it is possible to adjust the drag torque by varying the fluid filling level in the operating space, electromagnetically or through bi-metal control for example. Preferably appropriate mechanisms known from conventional liquid friction couplings are envisaged.

Through the provision of means for varying the filling level (controlled variant), the output speed in the drag area can be varied within broad limits, depending on requirements. If a bi-metal mechanism is provided, control can take place without the provision of, or connection to, an electronic control device. In addition, very low output speeds can be achieved if, through appropriate controlling of the fluid valve, a larger quantity of fluid is kept in the fluid reservoir.

Particularly preferred is a form of embodiment in which the means for setting the fluid in the at least one shear gap delimited by the armament and/or in the optionally envisaged constant shear gap have a fluid valve (control valve) with which the fluid flow from a fluid reservoir into the at least one shear gap or constant shear gap and/or from the shear gap or constant shear gap into the fluid reservoir can be influenced. The fluid valve can be actuated by means of a bi-metal mechanism or electromagnetic means for example. These can comprise an electromagnet specially intended for this purpose, with which a valve armature, for example a hinged armature, lifting armature or a rotation armature of the fluid valve can be adjusted. It is very particularly preferred if a separate electromagnet is dispensed with and, instead, the energisable winding of the friction disc coupling means is designed and adapted to the fluid valve in such a way that through suitable energising of the energisable winding, more particularly in lower energising range, the fluid valve of the viscous coupling can be actuated. In other words the hydraulic control valve of the viscous coupling (fluid valve) can be actuated by the electromagnet assembly of the friction disc coupling in order to adjust the slippage. Expressed in yet another way, in the case of the further developed coupling, an electromagnet assembly to actuate the armature of the friction disc coupling is designed and arranged in such a way that, preferably, depending on its effective energising, it controls the friction disc coupling as well as actuates/sets the fluid valve of the viscous coupling and thereby adjusts the torque transmission in the quantity of fluid, more particularly quantity of oil, available in the shear gap in the liquid friction coupling. In accordance with the further development a common electromagnet assembly is envisaged for the friction disc coupling means and liquid friction means with which both the armature of the friction disc coupling and an armature for adjusting the slip of the integrated liquid friction coupling assigned to a fluid valve (control valve) of the liquid friction coupling means can be operated. According to a first form of embodiment, two magnetic flux circuits can thus be assigned to/produced by the electromagnet assembly, whereby a first flow circuit serves to actuate the armature of the friction disc coupling and the second magnetic flux circuit serves to adjust the armature of the electromagnetically operable hydraulic control valve for setting the slip of the liquid friction coupling.

Alternatively an embodiment with a single magnetic circuit can be implemented, particularly if, for adjusting the hydraulic valve of the viscous coupling, a rotational armature is provided. It is of course also possible to actuate differently designed armatures, such as sliding armatures, lifting armatures or hinged armatures of the fluid valve with a single circuit. In the event of implementing a single flow circuit it must also bridge the air gap/working gap between both armatures (friction disc armature and control valve armature of the viscous coupling).

In the case of using a bi-metal mechanism for adjusting the valve element of the control valve of the fluid friction coupling means, it has proven to be advantages to provide the control valve on the primary side, i.e. to connect it directly or indirectly to the drive shaft in a torque-proof manner, in order to be able to assure very short reaction times. This also results in advantages in terms of the switch-off time through greater slip coordination in the case of full engagement of the viscous part of the coupling. In such a form of embodiment it has proven to be of particular advantage if the bi-metal mechanism for operating the primary-side control valve passes axially through the secondary part, whereby in this case sealing can take place by way of a radial shaft seal for example. Preferably at the end, there is a bi-metal spiral of the bi-metal mechanism on a fastening passed axially through the secondary side (i.e. though the output). Preferably a valve arm of the control valve moved with the drive can be moved, more particularly pivoted, relative to the drive and, more particularly, relative to the aforementioned primary side-side fastening. Even more preferably this valve arm passes through the aforementioned fastening attached to the drive shaft in the axial direction.

Alternatively, a longer drive shaft, passing through the secondary side can be provided through which the bi-metal mechanism passes and to the end of which a bi-metal element is fastened.

In the case of combining means for varying the filling level with a constant shear gap that is not delimited by the adjustable armature but, preferably, by a disc connected to the drive shaft in a torque-proof manner, it is particularly advantageous if the valve opening of the valve (fluid valve/control valve), with which the fluid flow from a fluid reservoir into the operating space can be influenced, is provided in this disc.

### BRIEF DESCRIPTION OF THE DRAWINGS

Further advantages, features and details of the invention are set out in the following description of preferred examples of embodiments as well as by way of the drawings. In these:

FIG. 1 shows a cross-sectional partial view of a coupling assembly comprising a drive train for driving a fan wheel in a motor vehicle with uncontrolled fluid friction means.

FIG. 2 shows an alternative example of embodiment of a coupling assembly with conical friction surface pairs,

FIG. 3 shows an alternative example of embodiment of a coupling assembly with friction disc and liquid friction coupling means, whereby the latter comprise a bi-metal mechanism for operating a control valve in order to herewith be able to influence the fluid level in the shear gaps of the liquid friction coupling means,

FIG. 4 shows a further alternative example of embodiment of a coupling assembly with means for influencing the fluid filling level of the shear gaps, whereby these also comprise a bi-metal mechanism, whereby, however, the fluid valve (control valve) is arranged on the primary side, i.e. the fluid valve opening is connected to the drive shaft in a torque-proof manner.

FIG. 5 shows a further alternative form of embodiment of a coupling assembly with means for adjusting the fluid level, whereby on one side, facing away from the friction surfaces of the friction disc coupling means, the fluid friction coupling means have a further shear gap in the form of a labyrinth gap, and

FIG. 6 shows a further alternative example of embodiment of a coupling assembly in which the means for adjusting the fluid level in the shear gap have electromagnet means, which in this specific example of embodiment are formed by the energisable winding of the friction disc coupling means.

### DETAILED DESCRIPTION

In the figures, identical elements and elements with the same function are shown with the same reference numbers.

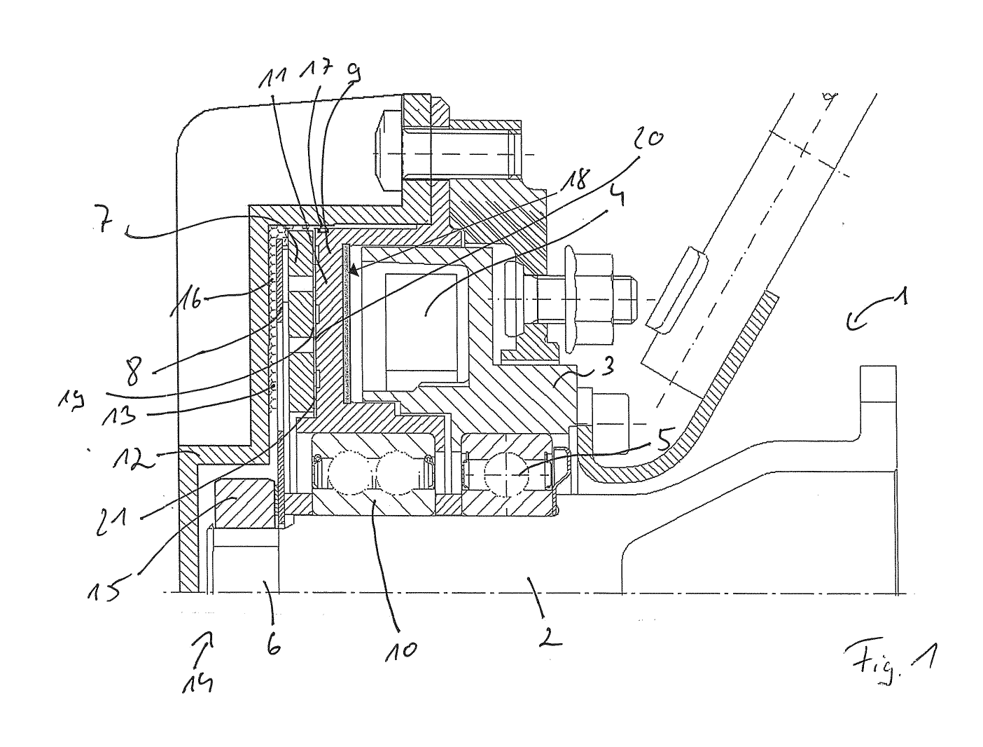

In FIG. 1 the upper half of a coupling assembly 1 in a secondary unit train of a motor vehicle is shown.

The coupling assembly comprises a drive shaft 2 which is driven by an internal combustion engine (not shown) and is rotatable relative to an electromagnet assembly 3. The fixed electromagnet unit 3, comprising an energisable winding 4, is supported on the drive shaft 2 in the radial and axial direction via a roller bearing 5 which is here in the form of ball bearings.

In the region of a free end 6 of the drive shaft 2 an armature 7, designed in the form of an armature disc (armature disc), is attached in torque-proof manner via a disc-shaped return spring 8. Through energising the winding 4, the armature can be moved relative to an output 9 which is arranged to rotate relative to the drive shaft 2 and is supported thereon via a roller bearing 10 in the form of a double ball bearing. Fan blades, for example, can be attached to the output 9. It is also conceivable to design the output 9 as a pulley in order to be able to transfer the torque via it to the secondary unit. In the example of embodiment in accordance with FIG. 1 the armature 7 is axially braced again the inner running rings of the roller bearings 5, 10 by means of a nut 15 which is screwed axially on to an external threaded section at the end of the drive shaft 2.

The output 9 comprises a rotating pole surface part 11 which is located axially between the armature 7 and the energisable winding 4. The pole surface part 11 is screwed to a part of the housing 12 of the output and with this delimits an operating space 13 for the coupling 14 designed as a combined friction surface and liquid friction coupling, in which the armature 7, axial in this case, is arranged in an adjustable manner.

As shown graphically in FIG. 1, the operating space 13 is filled with a shearable fluid 16, in this case a silicone oil. This serves to transfer the drag torque between the armature 7 and the output 9 when the armature 7 is not in contact with or frictionally coupled to the output 9. So that the fluid 16 cannot emerge from the operating space 13 into the area of the winding 4, the operating space 13 is sealed way of an elastomer seal in the form of an O-ring. The elastomer seal 17 is located radially between the pole surface part 11 of the output 9 and the housing 12 of the output 9.

Reference number 18 denotes a sealing disc which constitutes one possibility of closing off the operating space in an oil-tight manner. The pole surface part 11 of the output 9 has magnetic separating means which contain either air (gap) or a non-ferritic filler (e.g. bronze). These are not shown in the cross-section.

Axially between a friction surface 19 of the armature facing the winding 4 and an opposite friction surface 20 of the output 9, more precisely of the pole surface part 11, is an axial shear gap 21, extending radially as well as circumferentially, in which the fluid 16 is sheared and transfers a torque (drag torque) between the armature 7 and the output 9. The transferred torque is not only dependent on the speed of the drive shaft 2, but also on the (mean) gap width of the shear gap 21. This gap width can be adjusted by appropriate energising of the winding 4. Provided for this are control means, which are not shown, via which the winding 4 can be energised with different PWM signals in order to generate different effective current strengths, whereby the resulting effective current strength determines the shear gap width. Only as of the exceeding of a defined effect current strength does the armature 7 come into frictional contact on the output 9 in order to then transfer the full drive torque to the output.

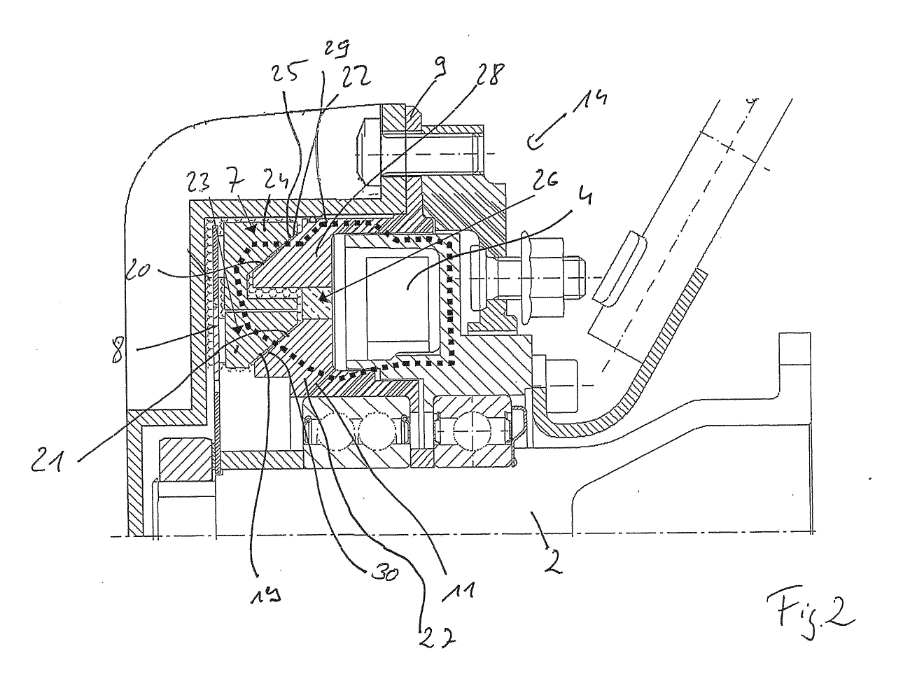

The basic structure of the example of embodiment in accordance with FIG. 2 corresponds to that of the example of embodiment in accordance with FIG. 1 so that in order to avoid repetition, only differences with regard to the example of embodiment in accordance with FIG. 1 will essentially be set out below. With regard to the (evident) common features, reference is made to FIG. 1 with the relevant description of the figure.

In contrast to the example of embodiment in accordance with FIG. 1, the design of the friction surfaces as well as the shear gap is different. In particular, their geometry is selected so that larger friction surfaces result, on the one hand in order to be able to transfer greater drag torques when the armature 7 and output 9 are not frictionally coupled to each other, and, on the other hand, to be able to transfer greater drive torques when the armature 7 and output 9 are frictionally connected.

In addition, in FIG. 2 the magnetic flux 22 on energising the energisable winding is shown.

Above all, FIG. 2 shows the different design of the armature 7. In the shown example of embodiment it has two pole parts, namely a radial inner pole part 23 and, radially at a distance therefrom, an outer pole part 24. Each pole part 23, 24 has a friction surface 19, 25, whereby in the shown example of embodiment both friction surfaces 19, 25 are (internally) conically contoured. Corresponding to each friction surface 19, 25 of the armature 7, which each can be formed by a preferably organic coating, is an opposite friction surface 20, 30, aligned in parallel on the output 9, more precisely on the pole surface part 11. The friction surfaces 19, 30 and 25, 20 each form a friction surface pair. A radial inner friction surface 30 is located on a radial inner section 27 of the pole surface part 11, which in the radial direction is separated from a radial outer section 28 by a separation section 26 of non- or poorly-conducting magnetic material. The magnetic flux therefore initially passes from one of the sections into the armature 7, there radially from one of the pole sections to the adjacent pole section and back into the other section of the pole part 11. In doing so the magnetic flux crosses both the radial inner shear gap 21 as well as the radial outer shear gap 29. In the same way as in the example of embodiment in accordance with FIG. 1, the mean shear gap 21, 29 can be set and maintained by appropriate modulated energising of the winding 4. As of the exceeding of a defined effective energising, the armature 7, which can be adjusted against the return spring 8 by way of the winding 4, is in contact with pole section part 11 so that the full drive moment can be transferred from the drive shaft 2 to the output 9 and thus to the secondary unit.

The structure of the example of embodiment in accordance with FIG. 3 essentially corresponds to the structure of the example of embodiment in accordance with FIG. 1, so that in order to avoid repetition only the differences will be set out below. With regard to the common features, reference is made to FIG. 1 with the relevant description of the figure.

In the example of embodiment in accordance with FIG. 3, the liquid friction coupling means are not uncontrolled but have means for adjusting the means 31 for setting the fluid level in the shear gaps 21 and 32 of the liquid friction coupling. The shear gaps are, on the one hand, the already explained shear gap between the friction surfaces 19, 20 of the friction coupling, and, on the other hand, the shear gap 52, which in the shown example of embodiment runs parallel to the shear gap 21. The shear gap 52 is on the rear of the armature 7, i.e. on a side facing away from the friction surfaces 19, 20 and is delimited by the armature 7, more precisely by its return spring 8 on one side and the housing 12 of the output 9 on the other side. As in the preceding examples of embodiment, the output 9 serves to drive a secondary unit in a motor vehicle, more particularly fans. The shear gap 52 is designed in such a way that through shearing of the fluid within it, preferably a silicone oil, drag torques are transferred between the armature and the output 9. Through the shearing of the fluid drag torques are also transferred between the armature 7 and pole surface part 11 of the output 9 adjacent to the shear gap 21.

As the shear gap 52, like the shear gap 21, is delimited by the adjustable armature, its gap width is variable and changes with corresponding energising of the energisable winding 4.

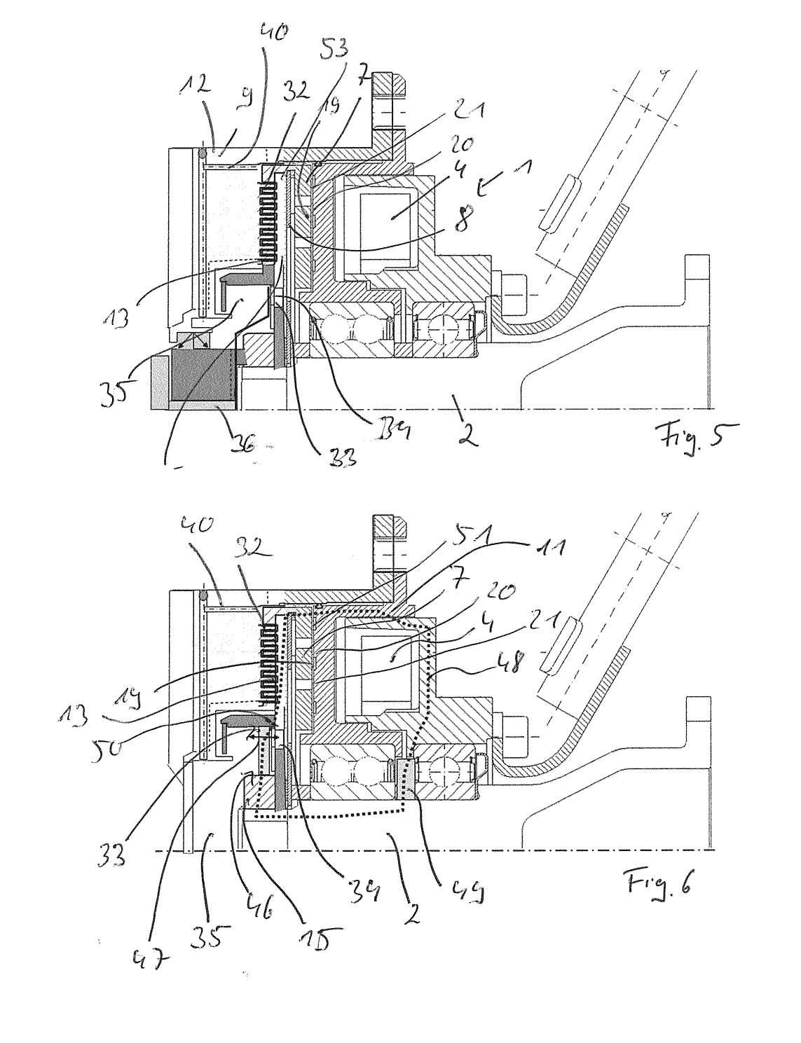

Instead of the variable gap 52, a constant shear gap can be provided, as in the examples of embodiment in accordance with FIGS. 5 and 6 for example. This would then have to be delimited by a component, more particularly a rigid disc, connected to the drive shaft 2 which on displacement of the armature does not move with the latter. This disc preferably jointly arranged with the armature in a common operating pace, could be arranged to the left of the return spring 8 in the plane of the drawing, wherein it would be conceivable to fasten the adjustable armature to this rigid disc by way of suitable return spring means so that the return spring, unlike in the shown example of embodiment, would not have to be attached directly to the drive shaft 2.

As has already been stated, the liquid friction coupling means are controlled and for this purpose have a fluid valve 33 on the output side by means of which the fluid filling level in the shear gaps 21, 32 can be adjusted. The fluid valve comprises a valve opening 34 through which the fluid to be sheared can flow through the effect of centrifugal force from a fluid reservoir 35 into the operating space 13 of the shear gap 21, 52 if the valve opening 34 is opened. For opening and closing the valve opening a bi-metal mechanism 36 is provided, comprising a bi-metal spiral spring 37, which is arranged on the output 9, more precisely the housing 19, at an axial distance from and decoupled from the drive shaft 2, whereby depending on a temperature, more particularly an air temperature of cool air flowing through a cooler, the spiral spring 37 moves, here in the circumferential direction, and thereby pivots a valve arm 38 (pivot arm) attached to the bi-metal spiral spring 37 in the circumferential direction so that an end section 39 of the valve arm 38 forming a valve body is pivoted relative to the valve opening 34 and, depending on the temperature to which the bi-metal spiral spring 37 is exposed, more or less opens the valve opening 34. Preferably the bimetal spiral spring 37 is designed so that the adjustment path is proportional to the temperature change.

As has been stated, fluid, in this case silicone oil, can therefore flow from the fluid reservoir 35 via the valve opening 34 into the operating space 13 when the coupling assembly rotates. Due to centrifugal force the fluid is pushed radially outwards and can flow back into the fluid channel 35 via a return flow chicane 40 comprising an axial channel and a radial channel as well as a dynamic pressure mechanism (not shown) which produces the required pressure before the channels to bring about a flow in the direction of the fluid reservoir which is provided in the housing section 12. In the example of embodiment in accordance with FIG. 3, as in all liquid friction couplings with a fluid valve (control valve), PWM activation of the energisable winding 4 for influencing shear gap 21 and thus an opposing influencing of the shear gap 52 can be dispensed with. However, if required, such a control possibility can be additionally provided which is of particular interest if the shear gap 21, 52 is designed so that with it different maximum drag torques can be transferred.

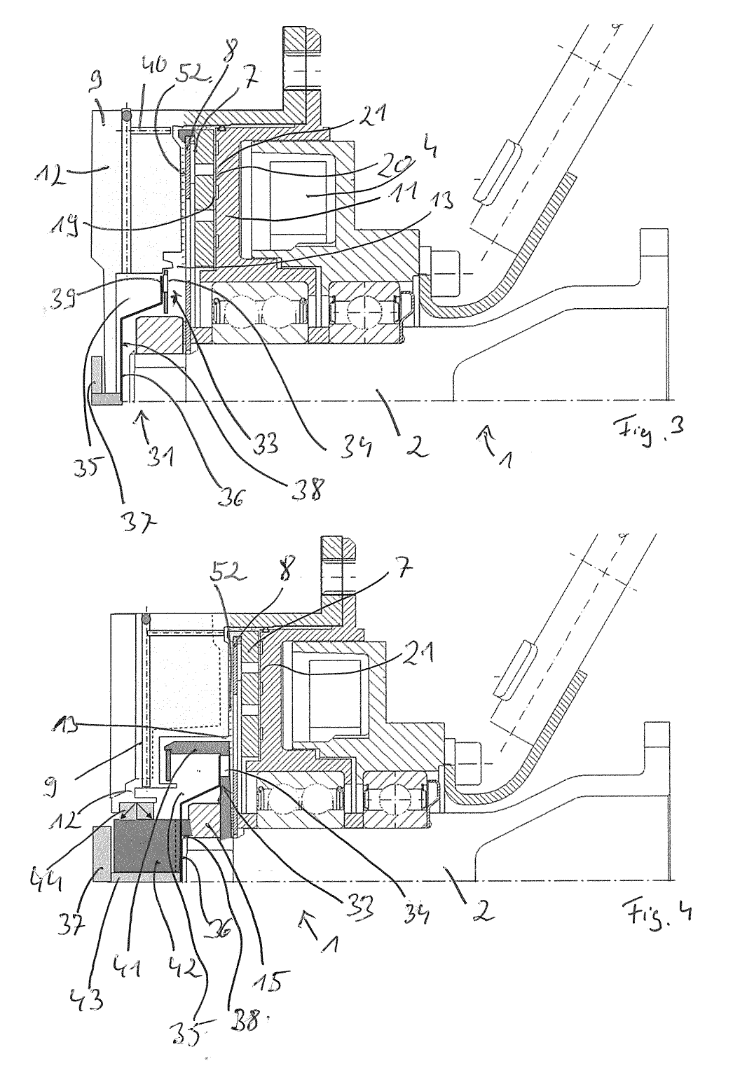

The example of embodiment of a coupling assembly in accordance with FIG. 4 essentially corresponds with the structure of the example of embodiment in accordance with FIG. 3 so that in order avoid repetition, reference is made to the example of embodiment in accordance with FIG. 3 and additional to the example of embodiment in accordance with FIG. 1 with accompanying descriptions of the figures.

In the example of embodiment in accordance with FIG. 4 too, the coupling assembly 1 has controlled liquid friction coupling means with a bi-metal mechanism 36 for varying the fluid level in the shear gaps 32, 21, whereby in contrast to the example of embodiment in accordance with FIG. 3, the fluid valve 33 and, in particular, its valve opening 34, are arranged on the drive side—this means that the valve opening 34 and the, in this case for assembly reasons, two-part component 41 bearing it and delimiting the operating space 13 is connected to the drive shaft 2 in a torque-proof manner. For this the component 41 is axially jammed by means of the nut 15 between the return spring 8 of the armature 7 and the aforementioned nut 15 which at the end is screwed onto the drive shaft 2. In the drawing, to the left of the nut 15 there is a drive shaft extender 42 which is connected to the drive shaft in a torque-proof manner and through which passes an axis 43 of the bi-metal mechanism which connects the bi-metal spiral spring 37, also arranged on the output side, to the valve arm 38 so that the latter can be pivoted relative to the valve opening 34, more particularly by around 10° to 15°. The output 9, more particularly the housing section 12 is sealed by means of a radial shaft seal 44 to seal the fluid reservoir 35 with regard to the extender 42 (simultaneously connection piece for the bi-metal element), which is attached to the drive shaft 2 in a torque-proof manner.

Below the example of embodiment in accordance with FIG. 5 is described, which essentially corresponds with the example of embodiment in accordance with FIG. 4, so that in order to avoid repetition only the difference will be set out. With regard to the common features reference is made to FIG. 4 and additionally to FIGS. 3 and 1 with the relevant descriptions of the figures.

The coupling assembly 1 in accordance with FIG. 5 also comprises a bi-metal mechanism 36 as well as liquid friction coupling means controlled by a fluid valve 33 designed as described in the case of the example of embodiment in accordance with FIG. 4. In contrast to the example of embodiment in accordance with FIG. 4, the (additional) shear gap 32 facing away from the friction surface 19, 20 is not delimited by the armature 7. Instead, this shear gap is designed as a constant shear gap 32, the gap width of which does not change when the armature 7 is adjusted through energising the winding 4. This is achieved in that in addition to the armature 7, a comparatively rigid disc 53 is provided which is connected to the drive shaft in a torque-proof manner. The armature 7 can be axially adjusted relative to the disc 53 through energising the winding 4. The constant shear gap can be designed as a conventional axial gap, or, preferably, be formed as a labyrinth as in the shown example of embodiment. For this the disc 53 and the output 9, more particularly housing section 12, interconnect in a tooth-like manner in the axial direction. To make this possible the disc 53 has a toothed geometry which axially engages in a corresponding toothed geometry of housing section 12 so that a labyrinth-like shear gap 32 is formed that has alternating radial and axial sections (shear surface pairs), wherein two axial sections aligned in the same axial direction adjoin each radial section so that the fluid has to change its axial direction after each radial section. In this way large shear surfaces can be provided in the smallest space. Alternatively, an embodiment is of course of also possible in which the disc 53 is not a disc directly attached to the shaft 2, but a ring disc component which is arranged on the side of the return spring facing away from the friction surfaces 19, 20 and which in this case is adjusted jointly with the armature on energising of the winding 4. In this case the gap marked with reference number 32 is not a constant shear gap, but a variable shear gap.

In the example of embodiment in accordance with FIG. 5, when the coupling assembly is in operation and the valve opening 34 is open, the fluid flows from the fluid reservoir 35 into the operating space 13, i.e. the shear gap 21, 32 and can flow back via a return chicane 40 provided in the output. In a preferred form of embodiment the valve opening is provided in the disc 53. As in the example of embodiment in accordance with FIG. 4, a radial boring of the return path is outwardly radially closed by a ball.

The basic structure of the example of embodiment in accordance with FIG. 6 corresponds to the structure of the example of embodiment in accordance with FIG. 5 so that in order to avoid repetition, only differences will essentially be set out below. With regard to the common features, reference is made to the examples of embodiment in accordance with FIGS. 1, 3, 4 and 5 with the relevant descriptions of the figures.

In the shown example of embodiment the liquid friction coupling means are also controlled, however, not by means of a bi-metal mechanism, but by way of an electromagnet mechanism 46 comprising a pivoting armature 47, here shown to be axially pivotable for example, which can be actuated by way of electromagnet means in order to open the valve opening 34 on the drive side, i.e. the throughflow cross-section to a greater or lesser degree. The armature 47 is designed as a pivoting armature which is attached with its radial lower end on the drive side, in this case in the region of the nut 15, whereby on energising of the winding 4, its radial outer end can pivot relative to the valve opening 34.

In place of a pivoting armature, a rotational armature (turning armature) can be provides, or an axially displaceable armature piston. In the simplest case (not shown), the electromagnet means can comprise a separate electromagnet, i.e. as part of the fluid valve 33 and exclusively assigned thereto. Particularly preferable is the shown form of embodiment in which the electromagnet means are formed by the energisable winding 4 which serves to adjust the armature 7 of the friction disc coupling means. Indicated is the magnetic flux 48 which can be generated through energising the winding 4.

The design is such that on maximum energising, the armature 7 is adjusted in the direction of the winding 4, so that the friction surfaces 19, 20 are in frictional contact with each other. In a lower energising range the position of the valve armature 47 relative to the valve opening 34 can be influenced. It can be seen that the magnetic flux 48 is introduced into the drive shaft 2 via suitable magnetic conducting means 49 and reaches the valve armature 47, designed as a pivoting armature, and after passing through it must bridge an operating air gap 50 between the pivoting armature and the component with the valve opening 34 and then flows in the axial direction within the armature 7 in order to bridge a further operating air gap 51, more precisely the shear gap 21, in the direction of the pole surface part 11 of the drive.

A coupling assembly 1, as shown, for example, in FIG. 6, in which the valve 34 can be influenced/adjusted by way of the energisable winding 4 of the friction disc coupling means (irrespective of the specifically shown variant), can be designed with different control logics. Thus, in accordance with a first alternative it is possible for the valve 34 to be opened with increasing energising of the winding 4, whereby full opening is achieved as of a certain energising level, preferably between 30% to 50% of the maximum energising level. In accordance with a second alternative the valve 34 can be fully opened without energising of the winding 4 and closed with increasing energising. On maximum energising the friction disc coupling engages, i.e. the armature 7 comes into contact with the pole surface part 11.

1. A coupling assembly for transferring a drive torque from a drive shaft (2) to a secondary unit of a motor vehicle, comprising a drive shaft (2), an output (9) with at least one friction surface (20, 30), an armature (7) that is adjustable relative to the output (9) by energising an energisable winding (4) and that has friction coupling means with a friction surface (19, 25), as well as at least one liquid friction coupling means with a shear gap (21, 29, 52) filled with a fluid (16),
wherein
the friction coupling means and the liquid friction coupling means are part of a common coupling (14) designed as a combined friction disc and liquid friction coupling in which the adjustable armature (7) delimits the shear gap (21, 29, 52).

2. The coupling assembly according to claim 1, wherein the at least one shear gap (21, 29, 52) is formed between the armature (7) and the output (9) when the output (9) is not in contact with the armature (7).

3. The coupling assembly according to claim 2, wherein the shear gap (21, 29) is formed between the friction surface (19, 25) of the armature (7) and the friction surface (30, 20) of the output (9).

4. The coupling assembly according to claim 1, wherein the friction surface (19, 25) of the armature (7) and the friction surface (20, 30) of the output (9) run, at least in sections, at an angle to the radial direction of the armature (7).

5. The coupling assembly according to claim 1, wherein at least two friction disc pairs (19, 30; 25, 20), are provided.

6. The coupling assembly according to claim 1, wherein in addition to the shear gap (21, 29, 52) delimited by the adjustable armature (7), a constant shear gap (32) not delimited by the armature (7) is provided.

7. The coupling assembly according to claim 6, wherein the shear gap delimited by the armature (7) and the constant shear gap (32) are connected to each other in a fluid-conveying manner and are preferably arranged in a common operating space (13).

8. The coupling assembly according to claim 6, wherein the at least one constant shear gap (32), is designed as a gap labyrinth, and is arranged on a side facing away from the friction surface of the armature (7) and/or in an area radially adjacent to the friction surface of the armature.

9. The coupling assembly according to claim 8, claim 1, wherein the constant shear gap (32) provided on the side facing away from the friction surface of the armature (7) is designed in such a way that with it a larger maximum drag torque can be transferred between the armature (7) and the output (9) than with the at least one shear gap between the friction surfaces.

10. The coupling assembly according to claim 1, wherein on a side facing away from the friction surface (19, 25) of the output (9) a gap in the form of an axial gap, between the armature (7) and a further assembly component, more particularly a housing part or a constant shear gap (32), has a smaller area than all shear gaps (21, 29) and/or in the non-energised state of the winding (4) has a larger mean gap width than the at least one shear gap (21, 29).

11. The coupling assembly according to claim 1, wherein the friction surface (19, 25) of the armature (7) and/or the friction surface (20, 30) of the output (9) is/are formed of an organic, coating in order to increase the adhesive friction.

12. The coupling assembly according to claim 1, wherein a fluid-filled operating space (13) accommodating the armature (7) is sealed off from the outside by means of an elastomer seal (17).

13. The coupling assembly according to claim 1, wherein means for adjusting and maintaining different shear gap widths are provided.

14. The coupling assembly according to claim 1, wherein the energisable winding (4) has control means for energising the winding (4) with a modulated current.

15. The coupling assembly according to claim 1, wherein means for adjusting the fluid filling level in the shear gap (21, 29) and/or in the constant shear gap (32) are provided.

16. The coupling assembly according to claim 15, wherein the means for adjusting the fluid level in the at least one shear gap and/or in the at least one constant shear gap (32) comprise a fluid valve (33) with which the fluid flow from a fluid reservoir (35) into the at least one shear gap (21, 29) and/or the at least one constant shear gap (32) or from the at least one shear gap (21, 29) and/or the at least one constant shear gap (32) into the fluid reservoir can be influenced.

17. The coupling assembly according to claim 16, wherein the fluid valve (33) can be operated by way of a bi-metal mechanism or by way of electromagnetic means comprising the energisable winding (4) of the friction coupling means.

18. The coupling assembly according to claim 5, wherein the friction disc pairs are fully conically contoured.

19. The coupling assembly according to claim 5, wherein the friction disc pairs are at a distance from one another in the radial direction.
